(19) United States
(12) Patent Application Publication
(10) Pub. No.: US 2026/0194084 A1
(43) Pub. Date: Jul. 9, 2026

(54) METHOD FOR REDUCING THE INTENSITY OF SHOCK WAVES IN A CHANNEL

(71) Applicants: Denis Ernestovich LVOV, Saint-Petersburg (RU); Timofei Aleksandrovich DORONIN, rp. Bykovo (RU); Aleksei Dmitrievich GOLUBEV, g. Vsevolozhsk (RU)

(72) Inventors: Denis Ernestovich LVOV, Saint-Petersburg (RU); Timofei Aleksandrovich DORONIN, rp. Bykovo (RU); Aleksei Dmitrievich GOLUBEV, g. Vsevolozhsk (RU)

(21) Appl. No.: 18/868,089

(22) PCT Filed: Jun. 10, 2022
(86) PCT No.: PCT/RU2022/000189

§ 371 Date: Nov. 21, 2024

(51) Int. Cl. F15D 1/08; F41A 21/30

(52) U.S. Cl. CPC F15D 1/08; F41A 21/30

(57) ABSTRACT

The method of reducing the intensity of shock waves propagating in channels at the outflow of gas flows can reduce the shock load on the fastening elements or structural elements located in a channel, a pipe, a shaft, a corridor, or an engineering structure. At the same time, the infrastructure for the safe presence of a person in, for example, a shaft or near a channel along which the shock wave moves is significantly improved. The method also allows reducing the length of the shock wave run to the moment of its disintegration and reducing its intensity in cases when it is necessary to preserve the possibility of a straight passage through this channel of people, equipment, or any other objects or particles that are not homogeneous inclusions of this gas flow and move coaxially with it. In this case, the gas flow may act as a carrier flow for these inclusions. This method is intended to reduce the intensity of shock waves propagating in channels while maintaining the possibility of thorough passage of these channels for any bodies or objects that can move in these channels.

### FIELD OF APPLICATION

The method of reducing the intensity of shock waves propagating in channels at the outflow of gas flows can reduce the shock load on the fastening elements or structural elements located in a channel, a pipe, a shaft, a corridor, or an engineering structure. At the same time, the infrastructure for the safe presence of a person in, for example, a shaft or near a channel along which the shock wave moves is significantly improved. The method also allows reducing the length of the shock wave run to the moment of its disintegration and reducing its intensity in cases when it is necessary to preserve the possibility of a straight passage through this channel of people, equipment, or any other objects or particles that are not homogeneous inclusions of this gas flow and move coaxially with it. In this case, the gas flow may act as a carrier flow for these inclusions.

### PURPOSE

This method is intended to reduce the intensity of shock waves propagating in channels while maintaining the possibility of through passage of these channels for any bodies or objects that can move in these channels.

### PRIOR ART

Invention “A Method for Increasing the Explosion Safety of Nuclear Power Plants” is known from the prior art, patent RU 2 728 003, published on Jul. 28, 2020, IPC F42D 5/045, F42B 39/00, that involves placing an obstacle in the form of elastic shells damping out the impact on the surface to be protected against a shock wave. The invention relates to methods for reducing the impact of blast loads on industrial premises; it reduces the impact of the blast wave formed during an emergency explosion of fuel-air mixtures. However, it is disposable and requires restoring it every time. It does not maintain the straight passability of the channel for the bodies moving in it.

The invention “Cantilever Jet Muzzle Brake” is known, patent RU 2 741 127, published on Jan. 22, 2021, IPC F41A 21/30, F41A 21/34, in which in the channel a front cover is placed, which presses the spreader coils to each other, and the spreader coil is two truncated cones connected at the vertices. It reduces the shooter's exposure to harmful substances contained in the products of the shot and damps out muzzle flashes. However, it does not use the effect of reducing the intensity of shock waves propagating in a channel.

The invention “A Recoil Control for an Artillery Gun” is known, patent RU 2766 237, on Feb. 10, 2022, IPC F41A 21/32, in which expansion chambers with windows having front vertical walls are used and the internal working surfaces are arc-shaped in section. The expansion chambers pass into open annular channels towards firing. This increases the recoil control forces and reduces the crew's exposure to gases and shock waves. However, it does not solve the problem of reducing the intensity of shock waves propagating in a channel.

The application for the invention “Kochetov Safety Structure with a Protective Screen” is known, RU 2015 133 175, published on Feb. 14, 2017, IPC E04B 1/92, in which the partition is made in the form of bearing ribs arranged along the contour of the collapsing part, and the collapsing part is made in the form of two coaxially arranged recesses in the wall of the building, one of which, the outer one, is formed by the planes of a regular quadrangular truncated pyramid with a rectangular base, and the other, the inner one, is two inclined surfaces connected by the rib to form a groove. It is used to protect buildings but it utilizes breakable parts that cannot be repaired. It does not solve the problem of reducing the intensity of shock waves propagating in a channel and does not maintain the straight passability of the channel for the bodies moving in it.

Utility model “An Internal Combustion Engine Silencer” is known, patent RU 61350, published on Feb. 27, 2007, IPC F01N 1/02, in which the cut of the inlet nozzle is placed in the middle plane perpendicular to the longitudinal axis of the channel housing. The ratio of the volumes of the inlet, central, and outlet chambers is used, respectively. The free cut of the outlet branch pipe is tightly plugged and its section located in the central chamber is made with perforated through-holes. When such a silencer operates at the point of expansion of the gas pipeline (i.e. at the place of appearance of the chamber itself), a jump-likely increased wave resistance is created: a “wave plug”. That in certain frequency ranges of the sound spectrum prevents the unimpeded passage of sound through the silencer without noticeable attenuation, i.e. a decrease in the level of acoustic energy emitted into the environment is provided. It uses nodes (minima) of sound pressure fluctuations distributed over the three-dimensional space of the chamber on these own modes. However, the wave-damping effect is obtained by adjusting the end resonators formed by the annular volumes of the extreme chambers communicated with the nozzles using the perforation sections and by selecting the degree of perforation of the sections. It does not solve the problem of reducing the intensity of shock waves propagating in a channel using geometric optics and does not maintain the channel's straight passability for the bodies moving in it.

Invention “A Multifunctional Automatic System for Isolating Explosions of Gas-Dust-Air Mixtures in Underground Mining Workings and Explosion Isolation Devices Included in It” is known, patent RU 2 658 690, published on Jun. 22, 2018, IPC E21F 5/14, E21F 5/146, related to the technology of and technical means for protecting production and other personnel located in underground mining workings and equipment located in them and underground mining workings themselves against explosions of mine gas mixtures. The invention uses an explosion isolation system when the system response is tied to specific parameters of shock waves and/or radiation of the flame (flash) front formed during explosions (flashes) of gas-dust-air mixture mixtures in underground mining workings. However, sensors are used at a certain distance, which actuate the automatic system that creates an explosion suppression cloud from a functional extinguishing powder with high-pressure compressed gas energy. This is a complex and not always effective system. It does not use geometric optics to reduce the intensity of shock waves propagating in a channel.

The closest technical solution is described in the invention “An Expander, a Damper-Expander and a Device for Their Placement”, patent RU 2 720 500, published on Feb. 21, 2020, IPC F41A 21/30, in which the internal surfaces of each expansion chamber are a truncated cone and the inner walls of each expansion chamber consist of a truncated conical surface with a diameter of the first expansion chamber of at least 1.5 the diameter of the central hole and transverse diametrical cutoff partitions at the ends. It uses the gas flow properties in which the gas jets are distributed in such a way that as they move along the channel, the jets are distributed in a certain way with a change in their characteristics in each jet according to a given law. However, the effect in subsonic shock waves is worse. This invention does not use the effect of reflection and focusing of the incident shock wave using surfaces designed with account of geometric optics.

Therefore, technical solutions based on a variety of diffuser constrictions, funnels, etc., do not work well. The scientific and technical literature referenced in this description justifies this.

The known traditional method of damping shock waves by arranging labyrinths of various types has the significant disadvantage that the straight passability of the channel is not maintained. This, in turn, for example, in underground mines, does not allow the use of this type of protection of people and equipment from the impact of shock waves, since rail tracks for trolleys and trains are usually laid along the bottom of the mine, and the arrangement of expansion chambers requires the implementation of mine workings of a significant size.

In accordance with the foregoing, methods for reducing the intensity of shock waves in channels known from the prior art and devices of a known type will either not be effective, or cumbersome, or will not maintain the straight passability of the channel for bodies.

### INVENTIVE PROBLEM

From the dynamics of waves, it is known that there are only three ways to create resistance to the shock wave propagation (and thereby reduce its intensity), namely: shape (pressure) resistance, friction resistance, and inductive (wave) resistance, while from the laws of geometric optics, it is known that a parabola is the only geometric location of points of the surface capable of reflecting and focusing waves. Since the friction resistance arises mainly on the channel walls and for its use requires the arrangement of channels with walls of high roughness and large extension, a method was chosen as the main method of solving the problem, in which, by reflecting and focusing the incident shock wave with a parabolic reflector, a reflected counter shock wave is created with the creation of an area of increased pressure and wave resistance in the area of the focus point for the incoming shock waves. This, in turn, will cause a loss of their energy and a decrease in their intensity, and the possibility of arranging an opening of the required diameter in the center of the parabolic reflector will ensure the unobstructed straight passage of any bodies moving in the channel. By applying this method, the inventive problem of reducing the intensity of shock waves in a channel is solved.

### TECHNICAL RESULT

The proposed technical solution provides the following technical result:
reducing the intensity of shock waves propagating in a channel;
maintaining the straight passability of the channel for the bodies moving in it.

### EMBODIMENT OF THE INVENTION

The technical result is achieved due to the fact that the method of reducing the intensity of shock waves in a channel includes: the formation of a shock wave propagating in the extended channel at the outflow of the main pressurized gas flow together with a foreign body or bodies into the channel, installation of a reflector perpendicular to this gas flow and coaxial to its axis, the passage of a part of the gas flow through the through-hole of the reflector with the possibility of passage of the foreign body or bodies that move coaxially with the main gas flow and together with it through the through-hole of the reflector, formation of an area of increased density and pressure in front of the reflector in the advancing main gas flow causing an increase in resistance to the shock wave propagation using the calculated ratio of geometric dimensions of the reflector. New is that the inlet channel is placed upstream of the channel, the reflector is made parabolic, the parabolic reflector is placed in the channel housing downstream of the end of the inlet channel of the high-pressure flow, thus forming an extended through-channel; due to the geometry of the tubular-shaped channel housing, at least one working zone placed coaxially to the inlet channel or several working zones placed sequentially and coaxially to the inlet channel is formed, for which the parabolic reflector is placed in the working zone perpendicular to the extended through-channel and coaxial to its axis with the distance “h” between the end of the extended through-channel and the parabolic reflector or neighboring parabolic reflectors turned with the concave part of the parabolic surface towards the gas flow, wherein the distance “h” is not less than the diameter “d” of the through-hole in the parabolic reflector; in order to form an area of increased density and pressure upstream of the parabolic reflector, the reflector is made with the outer diameter “D” numerically equal to not less than 3 diameters of the hole “d” in this reflector, and the focal point of the parabolic surface of the reflector “F” is located from the cut of the inlet channel or the cut of the outlet hole of the previous reflector not further than half of the hole “d” in this reflector, wherein the working zone “a” in the form of an area of increased density and pressure for the incoming shock waves is formed between the inlet channel of the flow and the parabolic reflector as a result of interference of the reflected shock waves focused by the parabolic surface of the reflector, and the formed working zone “a” acts as an obstacle with increased resistance; the distance “h” between the end of the inlet channel and the parabolic reflector or neighboring parabolic reflectors is calculated based on the laws of geometrical optics, and is equal to at least the diameter of the aperture “d” of the parabolic reflector.

In a particular case, each working zone's length is not less than equal to one parabolic deflector hole diameter “d”.

The proposed design is illustrated by drawings that do not cover all embodiments of the channel with a barrier.

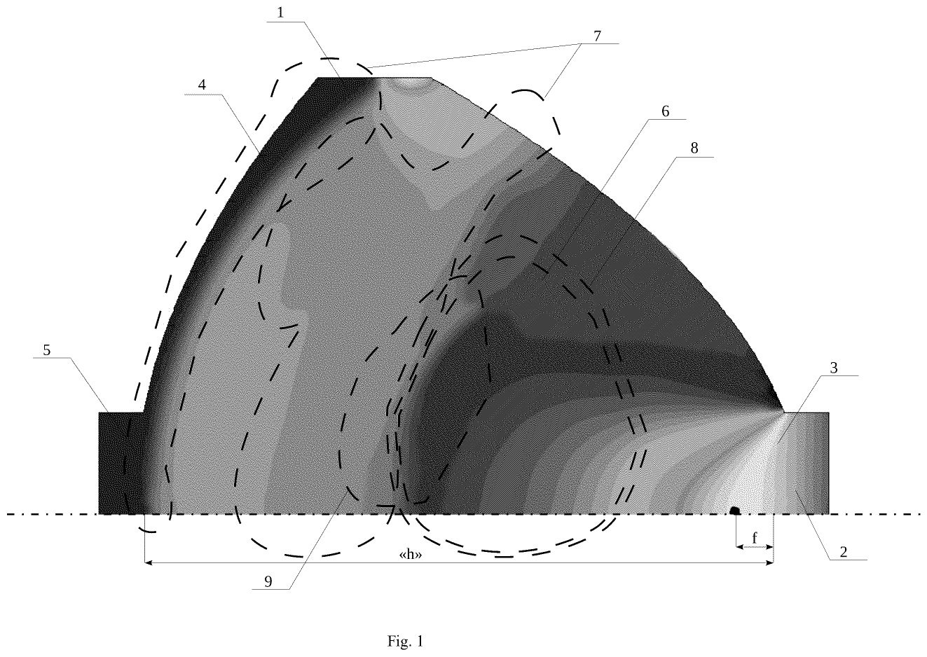

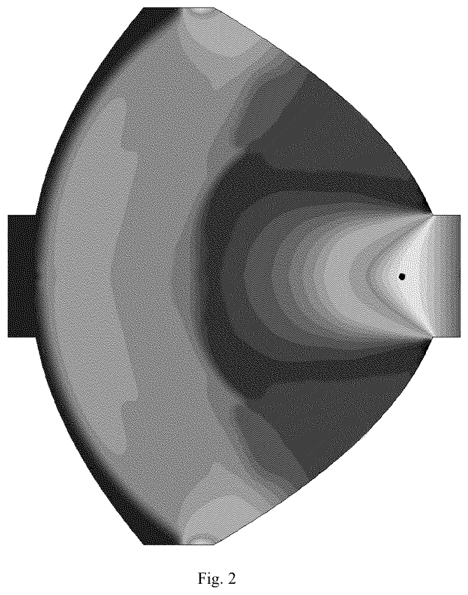

FIG. 1 shows an example of ½ of a structural element and the results of a computer simulation of the distribution of the pressure field from shock waves resulting from the outflow of a high-pressure gas flow from the inlet channel to the working zone at a minimum pressure of 0.3532 atm and up to a maximum pressure of 25.3384 atm with a wave travel time of 0.0393 ms.

FIG. 2 shows a picture of the shock wave passage obtained by computer simulation.

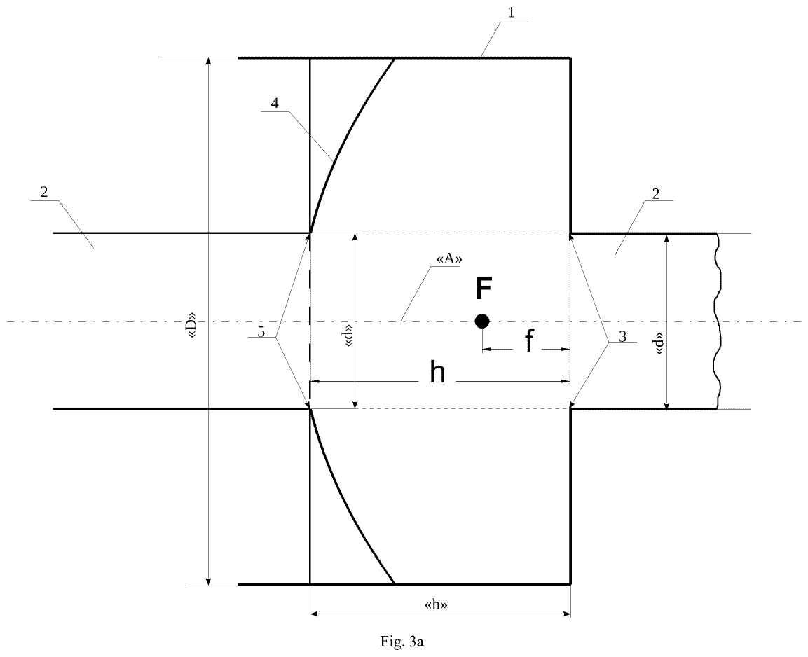

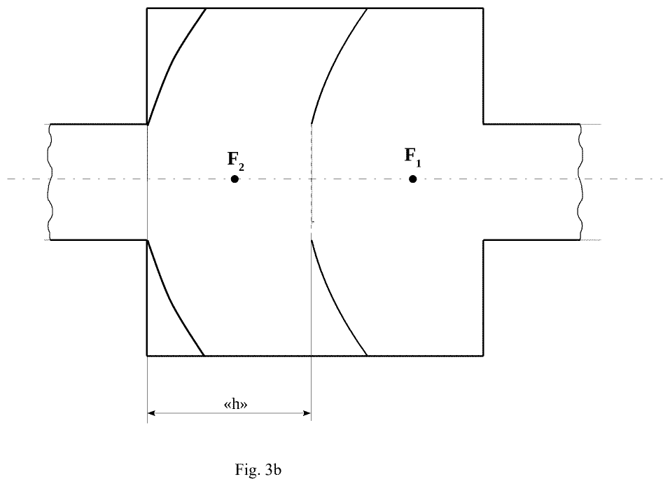

FIG. 3 shows the design of an extended channel a) with one parabolic reflector; b) with two parabolic reflectors.

### IMPLEMENTATION OF THE METHOD

A design implementing this method of decelerating a supersonic gas flow can be made as follows. In a cylindrical housing (1) made, for example, in the form of a tubular nozzle, there is an inlet channel (2) having an opening (3) from which a gas flow with inclusions flows out. At least one special obstacle made as a parabolic reflector (4) is placed in the extended channel. The reflector (4) is located in the housing (1) perpendicular to the gas flow and coaxial to its axis “A”; it has a through-hole (5) for passage of the body (or bodies) moving coaxially with the gas flow. The reflector is made in the form of a parabola with the focus “F” located on the axis “A”. In this case, the ratio of the geometric dimensions of the reflector: the diameter of the hole “d” and the diameter “D” of the reflector (4) and the distance “h” to the hole of the parabolic reflector (4) ensures the formation of an area of high pressure (6) in front of it, which exerts increased wave resistance to shock waves (7). The area (6) creates one working zone “a” (8) located coaxially with the inlet channel (2) and the housing (1). Zone (6) practically coincides with the working zone “a” (8). Several such working zones “a” can be arranged in series and coaxially by placing several reflectors (4) in series. The distance “h” between the end (opening) (3) of the inlet channel (2) and the reflector (4) or between two adjacent reflectors (4) is calculated based on the laws of geometric optics and is made equal to at least the diameter of the hole “d” in the corresponding reflector (4). In this case, the location of the focus of the parabolic reflector “F” (see FIG. 3a) or the foci “A1” and “A2” (see FIG. 3b) should be within the distance “h”. The reflector through-hole “d” is intended for the unobstructed passage of a body (or bodies) moving coaxially with the gas flow. The reflector (4) has an outer diameter “D”, numerically equal to at least 3 through-hole diameters “d”. The reflecting surface of the reflector (4) can be made with a different quality of approximation to the shape of the calculated mathematical parabola, including linear (stepwise) approximation of one or more conical surfaces. The quality of the approximation does not significantly affect the result. Due to the action on the parabolic reflector (4), the incident shock wave (7) is reflected, and the reflected shock wave (9) forms the area of high pressure (6).

As used herein, a high-pressure gas flow is understood to flow out of the inlet channel (2) with a gauge pressure of at least 3 atm.

The proposed method is implemented as follows.

The high-pressure gas flow going from the inlet channel (2) to the housing (1) expands, generates shock waves (7), which, propagating and reflecting from the parabolic reflector (4), are focused at point “F”. Due to interference around the focus point “F”, an area of increased density and pressure (6) is formed, getting into which the incident shock waves (9) experience increased resistance, lose some of their energy, and reduce their intensity.

Thus, the intensity of the shock waves (7) propagating in the extended channel (2) is reduced by creating the high-pressure region (6) and wave resistance arising on the path of the shock waves due to interference at the focus point “F” of the incident shock waves (9) re-reflected and focused by the parabolic reflector.

The distance “f” from the focus point “F” of the parabolic reflector to the cut of the inlet section (3) is selected to be not more than half the diameter of the inlet channel (2).

The diameter “d” of the hole (5) in the reflector (4) is selected equal to the diameter of the inlet channel (2) to maintain the passability of the extended channel for various bodies.

The distance “h” between the end of the channel (2) and the reflector (4) or between two adjacent reflectors is calculated based on the laws of geometric optics and is made equal to at least the diameter of the hole “d” (5). Thus, in a particular case, forming the length of each working zone “a” (8) equal to at least the diameter of the hole “d” of the reflector.

In the proposed method, decelerating, and as a result, reducing the intensity of shock waves propagating in the channel, is implemented by fulfilling the conditions for the formation of a high-pressure area and wave resistance overlapping the opening of the channel on their way, while maintaining the straight passability of the channel for the passage of various bodies.

The physical phenomenon that is used in the proposed method for reducing the intensity of shock waves in a channel has been studied and described in the following scientific and technical literature:
1. Frolov S. M. Efficiency of attenuation of shock waves in channels in various ways/Physics of Combustion and Explosion.—1993.—No. 1.
2. Zhou A., Wang K. and Wu Z. (2014) Propagation law of shock waves and gas flow in cross roadway caused by coal and gas outburst. International Journal of Mining Science and Technology, Vol. 24.
3. Mishuev A. V. Air shock wave in structures/Moscow, MGSU, 2015.
4. Ryabinin Yu.N. On the attenuation of shock waves propagating in the channels/Explosion Physics: A collection of experimental and research works in the field of explosion physics.—Moscow, IHF, 1955 No. 3.
5. Explosion Physics/Ed. by L. P. Orlenko. Moscow, FIZMATLIT, 2002.
6. Kratova Yu. V. Modes of propagation of plane detonation in gas suspensions in channels with a section break/Physic-chemical kinetics in gas dynamics. 2010 Vol. 9.
7. Bazhenova T. V. Non-stationary interaction of shock waves/Moscow, Nauka, 1977.

The minimum possible distance to the reflector “h” necessary to form an area of increased density and pressure (6) is calculated based on the laws of geometric optics and usually this value cannot be less than the diameter of the flow cross-section.

Parabolic reflectors are placed with a calculated spacing to smooth the pulsation in the extended channel.

All parameters can be both initially calculated analytically and selected based on the results of numerical computer simulation of shock wave propagation in outflowing gas using the finite element method based on the solution of the Novier-Stokes gas equations.

In addition to effectively reducing the intensity of shock waves by decelerating them, characterized by a high value of the coefficient of the ratio of the magnitude of the intensity reduction to the length of the working zone of the device, the possibility for straight passage of a body or bodies following the axis of the gas flow through the device is maintained.

The conducted field tests demonstrated good compliance of the results of practical tests with the results of computer simulation.

1. Method of reducing the intensity of shock waves in a channel, comprising generating in the channel a shock wave propagating in an extended channel when a main pressurized gas stream flow outflows into the channel together with a foreign body or bodies, installation of a reflector perpendicular to this gas flow and coaxial to its axis, passage of a part of the gas flow through the through-hole of the reflector with provision of possibility of passage through the through-hole of the reflector of a foreign body or bodies moving coaxially to the main gas flow and together with it, formation in front of the reflector in the incoming main gas flow of an area of increased density and pressure causing an increase in resistance to shock wave propagation by the calculated ratio of geometric dimensions of the reflector, characterized in that the inlet channel is placed upstream of the channel, the reflector is made parabolic, the parabolic reflector is placed in the channel housing downstream of the end of the inlet channel of the high-pressure flow, thus forming an extended through-channel; due to the geometry of the tubular-shaped channel housing, at least one working zone placed coaxially to the inlet channel or several working zones placed sequentially and coaxially to the inlet channel is formed, for which the parabolic reflector is placed in the working zone perpendicular to the extended through-channel and coaxial to its axis with the distance “h” between the end of the extended through-channel and the parabolic reflector or neighboring parabolic reflectors turned with the concave part of the parabolic surface towards the gas flow, wherein the distance “h” is not less than the diameter “d” of the through-hole in the parabolic reflector; in order to form an area of increased density and pressure upstream of the parabolic reflector, the reflector is made with the outer diameter “D” numerically equal to not less than 3 diameters of the hole “d” in this reflector, and the focal point of the parabolic surface of the reflector “F” is located from the cut of the inlet channel or the cut of the outlet hole of the previous reflector not further than half of the hole “d” in this reflector, wherein the working zone “a” in the form of an area of increased density and pressure for the incoming shock waves is formed between the inlet channel of the flow and the parabolic reflector as a result of interference of the reflected shock waves focused by the parabolic surface of the reflector, and the formed working zone “a” acts as an obstacle with increased resistance; the distance “h” between the end of the inlet channel and the parabolic reflector or neighboring parabolic reflectors is calculated based on the laws of geometrical optics, and is equal to at least the diameter of the aperture “d” of the parabolic reflector.

2. A method for reducing the intensity of shock waves in a channel according to claim 1, characterized in that a length of each working zone of at least one diameter of the hole “d” of the parabolic reflector is formed.
